(19) United States
(12) Patent Application Publication
(10) Pub. No.: US 2026/0145665 A1
(43) Pub. Date: May 28, 2026

(54) METHOD AND APPARATUS FOR CONTROLLING AUTOMATED PARKING FOR VEHICLE

(71) Applicants: Hyundai Motor Company, Seoul (KR); Kia Corporation, Seoul (KR)

(72) Inventor: Ho Choul Jung, Hwaseong (KR)

(21) Appl. No.: 19/278,616

(22) Filed: Jul. 23, 2025

(30) Foreign Application Priority Data
Nov. 28, 2024 (KR) 10-2024-0173446

(51) Int. Cl. B60W 30/06; B60W 50/14

(52) U.S. Cl. CPC B60W 30/06; B60W 50/14; B60W 2540/215; B60W 2552/53

(57) ABSTRACT

A method for resuming automatic parking of a vehicle is performed by a processor, and includes determining whether deactivation of an automatic parking system is required; deactivating the automatic parking system in response to determining that the deactivation is required; storing, at a time point when the automatic parking system is deactivated, vehicle position information and parking space recognition information; determining whether a condition for resuming automatic parking is satisfied; and reactivating the automatic parking system based on the stored vehicle position information and the stored parking space recognition information in response to determining that the condition for resuming is satisfied.

### CROSS-REFERENCE TO RELATED APPLICATION

This application claims under 35 U.S.C. § 119 (a) the benefit of Korean Patent Application No. 10-2024-0173446, filed on Nov. 28, 2024, the entire disclosure of which is hereby incorporated herein by reference in its entirety.

### BACKGROUND

### (a) Technical Field

The present disclosure relates to a method and an apparatus for controlling automatic parking for a vehicle, more particularly, to the method and apparatus that enables automatic parking by utilizing previously searched parking space information when an automatic parking function is resumed after being temporarily deactivated during operation.

### (b) Description of the Related Art

Vehicles have been developed with certain autonomous or semi-autonomous features. For example, Remote Smart Parking Assist (RSPA) is a technique that allows a vehicle to automatically park without human intervention. An RSPA system may calculate a parking path by using data collected from sensors provided in the vehicle, and may safely locate the vehicle in a parking space. Specifically, the RSPA system detects a surrounding environment, and recognizes the parking space by using a wide-angle camera and an ultrasonic sensor which are mounted on the vehicle. The RSPA system calculates a current position and a target position of the vehicle, based on the recognized parking space information, and thereafter, controls the vehicle to complete parking.

In existing RSPA systems, when the system is deactivated by user intervention, and the like for safety—for example, when the user moves the vehicle or a speed of the vehicle exceeds a speed limit-any previously searched parking space information is cleared. As a result, even if a parking space had been successfully located before the system was deactivated, such information is lost, and the search process must be restarted from the beginning when attempting to resume automatic parking. Thus, there is a need for a technology that preserves parking space information after system deactivation and enables automatic parking to resume, i.e., continue from where it left off.

### SUMMARY

The present disclosure is directed to providing a method and an apparatus capable of performing automatic parking by utilizing previously searched and stored parking space information when an automatic parking function is resumed after a temporary deactivation during operation.

Aspects to be achieved by the present disclosure are not limited to the aspects described above, and other aspects not described herein will be clearly understood by those skilled in the art from the following description.

According to a first aspect of the present disclosure, a method for resuming automatic parking of a vehicle includes: determining, by a processor, whether deactivation of an automatic parking system is required; deactivating, by the processor, the automatic parking system in response to determining that the deactivation is required; determining, by the processor, whether a condition for resuming automatic parking is satisfied; and reactivating, by the processor, the automatic parking system based on prior (or stored) vehicle position information and parking space recognition information in response to determining that the condition for resuming is satisfied.

According to a second aspect of the present disclosure, a method for resuming automatic parking of a vehicle includes steps of: determining, by a processor, whether deactivation of an automatic parking system is required; deactivating, by the processor, the automatic parking system in response to determining that the deactivation is required; storing, by the processor, at a time point when the automatic parking system is deactivated, vehicle position information and parking space recognition information; determining, by the processor, whether a condition for resuming automatic parking is satisfied; and reactivating, by the processor, the automatic parking system based on the stored vehicle position information and the stored parking space recognition information in response to determining that the condition for resuming is satisfied.

According to another aspect of the present disclosure, the present disclosure provide a method performed by an apparatus for resuming automatic parking of a vehicle, the method including determining whether deactivation of an automatic parking system is required; deactivating the automatic parking system in response to determining that the deactivation is required; storing, at a time point when the automatic parking system is deactivated, vehicle position information and parking space recognition information; determining whether a condition for resuming automatic parking is satisfied; and reactivating the automatic parking system based on the stored vehicle position information and the stored parking space recognition information in response to determining that the condition for resuming is satisfied.

According to a further aspect of the present disclosure, an apparatus for resuming automatic parking of a vehicle includes: at least one processor; and at least one memory coupled with the at least one processor to be operable, wherein the at least one memory stores instructions that cause the at least one processor to perform operations of: determining whether deactivation of an automatic parking system is required; deactivating the automatic parking system in response to determining that the deactivation is required; storing, at a time point when the automatic parking system is deactivated, vehicle position information and parking space recognition information; determining whether a condition for resuming automatic parking is satisfied; and reactivating the automatic parking system based on the stored vehicle position information and the stored parking space recognition information in response to determining that the condition for resuming is satisfied.

According to a further aspect of the present disclosure, the present disclosure provide an apparatus for resuming automatic parking of a vehicle, the apparatus including at least one processor; and at least one memory coupled with the at least one processor to be operable, wherein the at least one memory stores instructions that cause the at least one processor to perform operations in response to a result that the at least one processor executes the instructions, and the operations comprises: determining whether deactivation of an automatic parking system is required; deactivating the automatic parking system in response to determining that the deactivation is required; storing, at a time point when the automatic parking system is deactivated, vehicle position information and parking space recognition information; determining whether a condition for resuming automatic parking is satisfied; and reactivating the automatic parking system based on the stored vehicle position information and the stored parking space recognition information in response to determining that the condition for resuming is satisfied.

According to an aspect of the present disclosure, there is an advantageous effect of improving convenience and usability of the RSPA.

The effects of the present disclosure are not limited to the effects described above, and other effects not described herein will be clearly understood by those skilled in the art from the following description.

### BRIEF DESCRIPTION OF THE DRAWINGS

FIG. 1 is a block diagram schematically illustrating an automatic parking control apparatus according to one embodiment of the present disclosure.

FIG. 2 is a flow chart illustrating a method for a user to use an automatic parking system.

FIG. 3 is a flowchart illustrating a process in which the automatic parking control apparatus according to one embodiment of the present disclosure estimates a position of a vehicle, re-calculates a parking path based on the estimated position, and performs parking control.

FIGS. 4A, 4B, and 4C show exemplary situations in which, after completion of a parking space search during various types of reverse parking, and upon temporary deactivation and subsequent reactivation of the RSPA system, automatic parking is resumed by utilizing previously searched parking space information.

FIG. 5 shows an exemplary situation where, upon temporary deactivation and subsequent reactivation of the RSPA system during forward perpendicular parking, automatic parking is resumed by utilizing previously searched parking space information.

FIG. 6 shows an exemplary situation where, upon temporary deactivation and subsequent reactivation of the RSPA system during forward diagonal parking, automatic parking is resumed by utilizing previously searched parking space information.

FIG. 7 is a flow chart for resuming automatic parking when the system is deactivated by user intervention during automatic parking control.

FIG. 8 is a flowchart illustrating a method for resuming automatic parking according to one embodiment of the present disclosure.

FIG. 9 is a block diagram schematically illustrating an exemplary computing device which may be used to implement a method or an apparatus according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, various exemplary embodiments of the present disclosure will be described in detail with reference to the accompanying drawings. In the following description, like reference numerals designate like elements, although the elements are shown in different drawings. Furthermore, for clarity and for brevity, the following description of various exemplary embodiments will omit a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components.

The description of the present disclosure to be presented below in conjunction with the accompanying drawings is directed to describe exemplary embodiments of the present disclosure and is not intended to represent the only embodiments in which the technical idea of the present disclosure may be practiced.

A Remote Smart Parking Assist (RSPA) system may search for parking spaces using sensors and cameras, and may plan a parking path based on the searched parking space in order to position the vehicle in a parking space. However, the RSPA system has a problem in that the parking space recognition information is initialized when user intervention occurs or when the system is deactivated.

For example, when user intervention (e.g., manual backing of the vehicle, steering operation, acceleration, or braking) occurs after the parking space searching is completed but before entering the automatic parking control, there is a problem in that the previously searched parking space information is initialized.

In another example, similarly, there is a problem in that the previously searched parking space information is initialized when an automatic parking system is deactivated due to an override during smart parking control. Here, “override” refer to a situation in which the user manually operates the vehicle, such as steering, accelerating, or braking, or when the vehicle speed exceeds a preset speed limit.

In yet another example, when the user moves the vehicle after the parking space searching is completed and a parking type is selected, there is a problem in that the automatic parking system is deactivated, resulting in the initialization of the previously searched parking space information.

An automatic parking control apparatus according to one embodiment of the present disclosure maintains parking space information by using a memory function, and is capable of resuming vehicle control by utilizing the stored parking space information even when user intervention occurs or the system is deactivated.

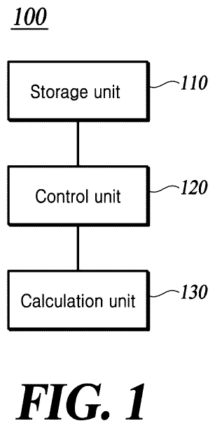

FIG. 1 is a block diagram schematically illustrating an automatic parking control apparatus according to one embodiment of the present disclosure.

As illustrated in FIG. 1, the automatic parking control apparatus (100) according to one embodiment of the present disclosure may include all or some of a storage unit (110), a control unit (120), and a calculation unit (130). Not all blocks illustrated in FIG. 1 are essential components, and in other embodiments, some blocks included in the automatic parking control apparatus (100) may be added, modified, or deleted. Meanwhile, the components illustrated in FIG. 1 represent functionally distinct elements, and may be implemented in a form in which at least one or more components are integrated with each other in an actual physical environment.

Each of the above elements (110, 120, and 130) may constitute modules and/or devices of the parking control apparatus (100), which may be a controller. For example, the above units of the parking control apparatus (100) may constitute hardware components that form part of a controller (e.g., modules or devices of a high-level controller), or may constitute individual controllers each having a processor and memory. The parking control apparatus (100) may include one or more processors and memory.

The storage unit (110) may store vehicle information, parking space recognition information, and automatic parking operation step information at a time point when the automatic parking system is deactivated. The vehicle information may include a transmission gear position signal, MDPS (Motor Driven Power Steering) information, wheel information, and vehicle speed information. MDPS refers to an electric power steering system that controls steering of the vehicle. The MDPS information may include a steering torque, a steering angle, a steering wheel speed, a steering wheel position, and the like. The wheel information refers to data necessary for detecting and controlling the condition and movement of the wheels of the vehicle. The wheel information may include wheel pulse information and non-driven wheel direction information. The wheel pulse information refers to data representing a rotational speed of each wheel. The non-driven wheel direction information refers to information indicating the steering direction of wheels that are not powered by driving force. The automatic parking operation step information when the system is deactivated may include vehicle position information at the time of system deactivation.

The calculation unit (130) may calculate a travel distance of the vehicle by using the vehicle information and the parking space recognition information. The calculation unit (130) may update a position of the vehicle based on the calculated travel distance, and re-calculate a parking path to the parking space based on the updated vehicle position.

The control unit (120) may perform parking control based on the re-calculated parking path.

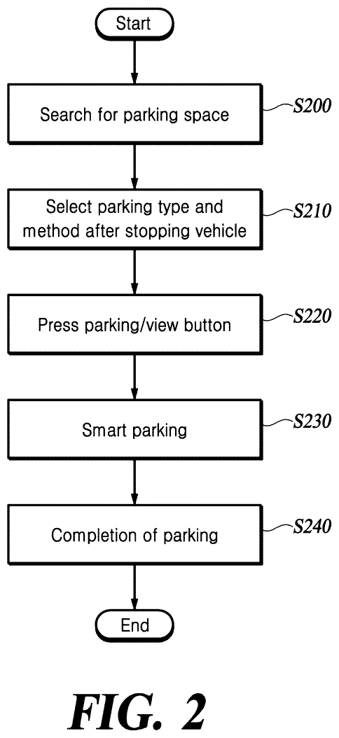

FIG. 2 is a flow chart illustrating a method for the user to use the automatic parking system.

The user may search for a parking space by using the automatic parking system (S200). The user may first bring the vehicle to a stop at an appropriate position before starting parking space searching function. The user may activate a parking space searching function by shifting the gear into D (Drive) position and pressing and holding a parking/view button of the vehicle. To search for a parking space, the vehicle is slowly driven forward at a speed of 20 km/h or less while maintaining a certain distance from a parking line. When the parking space searching is completed, information on the searched parking space is displayed via a Human Machine Interface (HMI). Here, the HMI refers to an interface through which the user interacts with the vehicle or receives information, and may include a navigation system, an instrument cluster, a touch screen, a voice recognition system, and the like which are provided in the vehicle.

When the parking space is completely searched for, the user may stop the vehicle and select a parking type (S210). When the vehicle stops, a user interface (UI) for selecting a parking type may be provided through the HMI (Human Machine Interface), allowing the user to select a desired parking type. The parking type may include perpendicular parking, parallel parking, or diagonal parking.

The user may select a parking method, which may include remote parking and smart parking. Remote parking refers to a parking method performed after the user exits the vehicle, whereas smart parking refers to a parking method performed while the user remains inside the vehicle. In the present disclosure, the term ‘automatic parking’ is used to refer to smart parking.

For example, when the user presses and holds the parking/view button and takes his/her foot off the brake pedal, the smart parking function is activated (S220).

Upon activation of the smart parking function, the RSPA system controls the vehicle to perform parking (S230).

Upon completion of parking, the gear is automatically shifted to the P (Park) position, and an electronic parking brake (EPB) is engaged (S240).

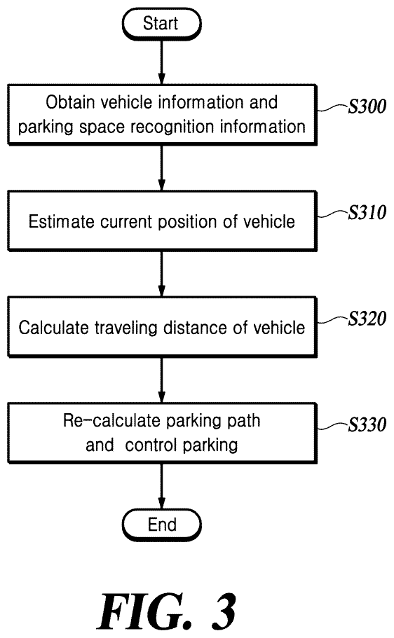

FIG. 3 is a flowchart illustrating a process in which the automatic parking control apparatus according to one embodiment of the present disclosure estimates a position of the vehicle, re-calculates a parking path, based on the estimated position, and performs parking control.

For example, after the RSPA system is deactivated due to user intervention during an operation, if the vehicle moves within a predefined support range, it may be necessary to resume automatic parking from the new position. To achieve this, the automatic parking control apparatus (100) may estimate the current position of the vehicle, and re-calculate the parking path based on the estimated position in order to perform parking control.

Referring to FIG. 3, the automatic parking control apparatus (100) may obtain vehicle information (S300). The vehicle information may include a transmission gear position signal, MDPS information, wheel information, vehicle speed information, and the like.

The automatic parking control apparatus (100) may obtain parking space recognition information. The parking space recognition information refers to information related to the parking space recognized during a process of searching for the parking space (S200), as illustrated in FIG. 2. For example, the parking space recognition information may include at least one of a location, size, orientation, and availability for each detected parking space.

The automatic parking control apparatus (100) may estimate the current position and the traveling distance of the vehicle based on the vehicle information and the parking space recognition information (S310). The automatic parking control apparatus (100) may set the position of the vehicle when the RSPA system starts as the origin point of a global coordinate system. The automatic parking control apparatus (100) may calculate a traveling distance in an x-direction, a traveling distance in a y-direction, and a heading angle of the vehicle (i.e., the angle relative to the vehicle's traveling direction), based on the position of the vehicle when the RSPA system starts. In addition, when the RSPA system is deactivated, the automatic parking control apparatus (100) may estimate the traveling distance and the current position of the vehicle, based on the position of the vehicle at the time of deactivation.

The automatic parking control apparatus (100) may calculate the total traveling distance of the vehicle based on the calculated traveling distance in the x-direction, the traveling distance in the y-direction, and the heading angle (S320).

The automatic parking control apparatus (100) may re-calculate a parking path based on the calculated traveling distance, the updated position of the vehicle, and the stored parking space recognition information (S330). The automatic parking control apparatus (100) may control the vehicle according to the re-calculated parking path such that the vehicle is accurately parked in the parking space from the updated current position.

The RSPA system has a problem in that the parking space recognition information is initialized when the user operates the system or the system is deactivated. For example, there is a problem in that the information on the parking space is initialized when the user reverses or overrides the vehicle before the vehicle enters the RSPA control after the parking space is completely searched for. As a result, the user needs to repeat the process of searching for the parking space again.

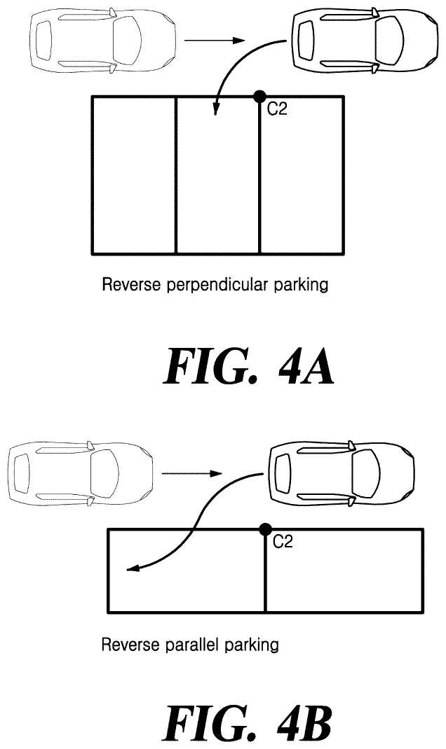

FIGS. 4A, 4B, and 4C illustrate exemplary situations where, after completion of parking space search during various types of reverse parking, and upon temporary deactivation and subsequent reactivation of the RSPA system, automatic parking is resumed by utilizing previously searched parking space information.

The automatic parking control apparatus (100) according to one embodiment of the present disclosure may stop displaying information on the parking space if the user manually reverses the vehicle or overrides the RSPA system after completion of the parking space search. However, the automatic parking control apparatus (100) does not delete but maintains the parking space recognition information. That is, the automatic parking control apparatus (100) maintains the information on the recognized parking space acquired during the parking space search process without initializing it.

Subsequently, when the user moves the vehicle forward again and the time point for re-displaying the parking space is reached, the automatic parking control apparatus (100) may immediately re-display the stored parking space recognition information. Here, the time point for re-displaying the parking space refers to the moment when the vehicle reaches a position where the automatic parking control according to the selected parking type can be initiated, based on the stored parking space recognition information and information detected by vehicle sensors during movement.

In the automatic parking control apparatus (100) according to one embodiment of the present disclosure, the time point for re-displaying the parking space may vary depending on the parking type. The reason is that a position for starting the automatic parking control and a parking path may be different from each other depending on the parking type.

FIG. 4A illustrates an exemplary situation where, after completing the parking space search during reverse perpendicular parking, and upon temporary deactivation and subsequent reactivation of the RSPA system, automatic parking is resumed by utilizing previously searched parking space information. FIG. 4B illustrates an exemplary situation where the same sequence occurs during reverse parallel parking. FIG. 4C illustrates an exemplary situation where the same sequence occurs during reverse diagonal parking.

Referring to FIGS. 4A, 4B, and 4C, point C2 represents a corner of the searched parking space that is closest to the position where automatic parking control can be initiated according to the selected parking type, and is hereinafter referred to as the “reference point for re-displaying the parking space.”

Referring to FIG. 1, after the parking space search is completed, the user may stop the vehicle, and select a parking type. However, when the user shifts the gear to the R (Reverse) position and begins reversing without selecting a parking type while the vehicle is stopped, the display of the information on the parking space via the RSPA HMI is terminated, and a rear view image is displayed instead. At this time, the information on the parking space is maintained without being deleted.

When the user shifts the gear to D (Drive) position and moves the vehicle forward again to reach the time point for re-displaying the parking space, the automatic parking control apparatus (100) immediately re-displays the information on the parking space. According to one embodiment of the present disclosure, in order to re-display the parking space during reverse parking, an x-coordinate of the center of a rear wheel of the vehicle needs to pass an x-coordinate of the reference point for re-displaying the parking space, and a sufficient road width needs to be secured for generating a parking path. Here, an x-axis represents a longitudinal axis of the vehicle, and a y-axis represents a lateral axis of the vehicle.

The user may resume the automatic parking by using the re-displayed information on the parking space. For example, the user may stop the vehicle and may select a parking type when the information on the parking space is re-displayed.

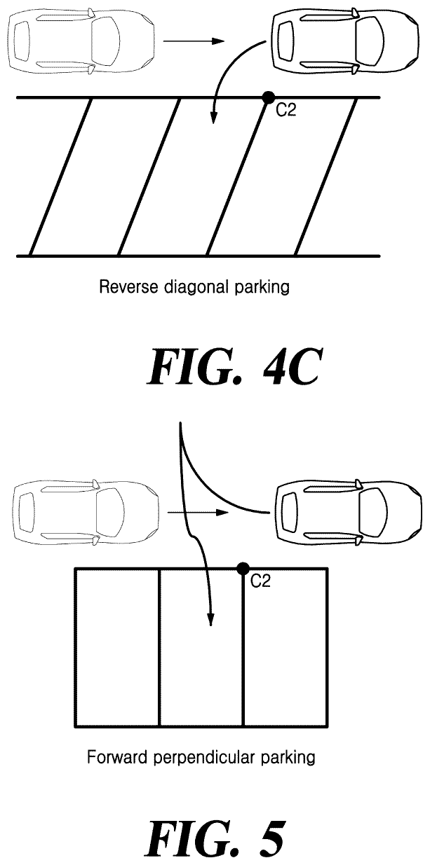

FIG. 5 shows an exemplary situation where, upon temporary deactivation and subsequent reactivation of the RSPA system during forward perpendicular parking, automatic parking is resumed by utilizing previously searched parking space information.

Referring to FIG. 5, point C2 represents a corner of the searched parking space that is closest to the position where automatic parking control for forward perpendicular parking can be initiated.

As in a case of the reverse parking, after the parking space search is completed, the user may stop the vehicle, and select a parking type. However, when the user shifts the gear to the R (Reverse) position and begins reversing without selecting a parking type while the vehicle is stopped, the display of the information on the parking space via the RSPA HMI is terminated, and a rear view image is displayed instead. In this case, the information on the parking space is maintained without being deleted.

When the user shifts the gear to D (Drive) position and moves the vehicle forward again to reach the time point for re-displaying the parking space, the automatic parking control apparatus (100) immediately re-displays the information on the parking space. According to one embodiment of the present disclosure, in order to re-display the parking space during the forward perpendicular parking, the x-coordinate of the center of the rear wheel of the vehicle needs to pass the x-coordinate of the reference point C2 for re-displaying the parking space.

When the center of the rear wheel of the vehicle passes the point C2, the automatic parking control apparatus (100) may simultaneously display a forward perpendicular parking space and a reverse perpendicular parking space. The user may resume parking by selecting any one of the forward perpendicular parking and the reverse perpendicular parking. In order for the user to select the forward perpendicular parking, the reverse perpendicular parking needs to be available, and a control path for the forward perpendicular parking needs to exist.

The user may resume the automatic parking by using the re-displayed information on the parking space. For example, the user may stop the vehicle to select a parking type when the information on the parking space is re-displayed.

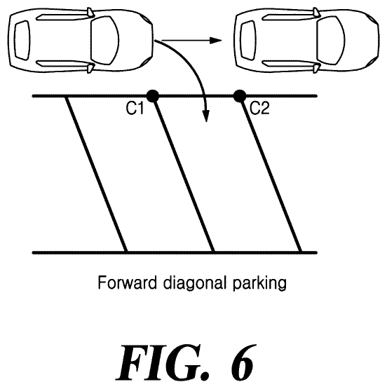

FIG. 6 shows an exemplary situation where, upon temporary deactivation and subsequent reactivation of the RSPA system during forward diagonal parking, automatic parking is resumed by utilizing previously searched parking space information. In the forward diagonal parking, the orientation of the parking space is slanted with respect to the vehicle's direction of travel, making it difficult to accurately recognize the parking space using ultrasonic sensors. Accordingly, a front camera of the vehicle should be utilized.

Referring to FIG. 6, point C1 represents the corner of the parking space that is recognized by using the front camera of the vehicle and is closest to the position where the automatic parking control for forward diagonal parking can be initiated. Point C2 represents the reference point for re-displaying the parking space in the case of reverse diagonal parking.

According to one embodiment of the present disclosure, when the parking space is searched for in advance by using an image recognition scan and the forward diagonal parking is performed from the current vehicle position (C1), the information on the parking space is maintained without being deleted even when the user shifts the gear to the R (Reverse) position and begins reversing.

When the user shifts the gear to the D (Drive) position and moves the vehicle forward again to reache the time point for re-displaying the parking space, the automatic parking control apparatus (100) immediately re-displays the information on the forward diagonal parking space. When the user moves the vehicle forward again and the forward diagonal parking space is recognized using the front camera of the vehicle, the automatic parking control apparatus (100) may re-display the forward diagonal parking space. That is, when the selected parking type is forward diagonal parking, the time point for re-displaying the parking space may correspond to a time at which the forward diagonal parking space is recognized using the front camera of the vehicle.

According to another embodiment of the present disclosure, when the user shifts the gear to the D (Drive) position and the x-coordinate of the center of the rear wheel of the vehicle passes the x-coordinate of the reference point for re-displaying the parking space the automatic parking control apparatus (100) may re-display the rear diagonal parking space.

When the automatic parking system is deactivated due to user intervention during automatic parking control, there has been a problem in that the parking space information is initialized, and the user must search for the parking space again from the beginning in order to resume automatic parking. According to one embodiment of the present disclosure, the automatic parking control apparatus (100) may allow automatic parking to be resumed if the system is re-entered after the vehicle moves within a predefined support range, even when the system is deactivated due to user intervention during RSPA control.

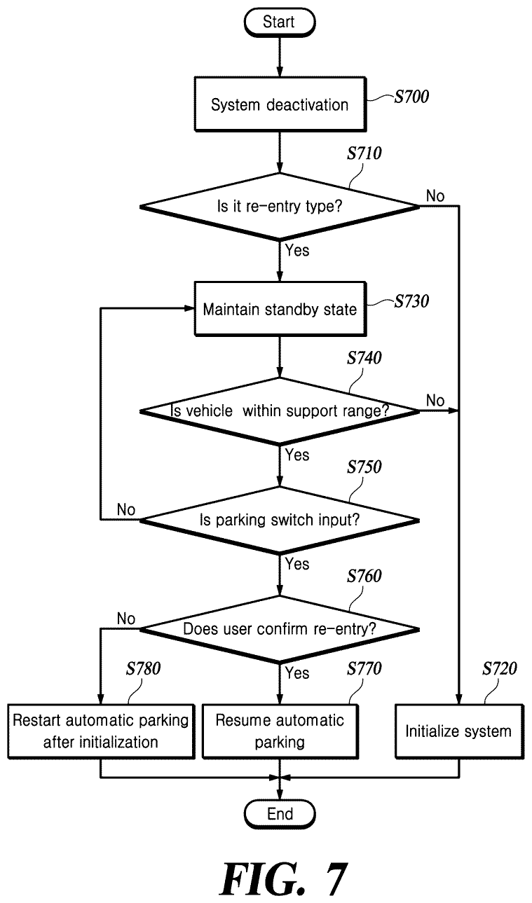

FIG. 7 is a flow chart for resuming automatic parking when the system is deactivated due to the user intervention during automatic parking control.

When there is the user intervention during the automatic parking control, the automatic parking control apparatus (100) may deactivate the system (S700). When the automatic parking system is deactivated, the gear is automatically shifted to the P position, and the electronic parking brake is engaged.

The automatic parking control apparatus (100) may determine whether the deactivation of the automatic parking system due to user intervention corresponds to a re-entry type (S710). Table 1 illustrates examples of deactivation cases of the automatic parking system that correspond to re-entry types.

TABLE 1

| Re-entry Type | Detailed Description of System Deactivation Cases |
|---|---|
| Override | System is deactivated if user overrides steering wheel during |
| | automatic parking control |
| | (Movable forward/rearward) when user arbitrarily moves vehicle |
| | within 0.5 m |
| | System is deactivated upon PDW OFF after RSPA ON |
| | System is deactivated upon detecting a navigation cancel button |
| | input during automatic parking control |
| Control Time | System is deactivated if more than 3 minutes and 50 seconds have |
| | elapsed after entering automatic parking control |
| Gear Shift Override | During automatic parking control, if a user inputs a gear shift |
| | while the vehicle is moving, it is determined to be a deactivation |
| | request. |
| | During automatic parking control, if a user inputs a gear shift to |
| | the R, N, or D position while the vehicle is stationary, it is |
| | determined to be a deactivation request. The system transitions |
| | directly to the input gear position and is then deactivated without |
| | performing additional safety measures. |
| EPB Engagement | If a user performs EPB engagement operation while the vehicle is |
| | moving, it is determined to be a deactivation request. |
| One Minute Pause | If the temporary stop is maintained for more than one minute, it is |
| | determined to be a deactivation request. |
| Unfastened Seat belt | During automatic parking control, if a driver's seat belt is |
| | unfastened while the gear position is other than the P position and |
| | a door is open, it is determined to be a deactivation request. |

The re-entry types according to the system deactivation cases may include override, control time expiration, gear shift override, EPB engagement, a one minute pause, and an unfastened seat belt. The override may include a case where the system is deactivated when the user overrides a steering wheel during automatic parking control. The override may include a case where the system is deactivated by terminating a Parking Distance Warning (PDW) after activating the RSPA. The override may include a case where the system is deactivated by confirming that a cancel button of a navigation is input during automatic parking control.

The control time expiration may include a case where the system is deactivated if more than 3 minutes and 50 seconds have elapsed after entering automatic parking control.

The gear shift override includes a case where a user inputs a gear shift while the vehicle is moving during automatic parking control and the automatic parking system is deactivated. The gear shift override includes a case where the driver inputs the R/N/D gear in a stopped state of the vehicle during control and the automatic parking system is deactivated. The gear shift override includes a case where the automatic parking system is deactivated after shifting to the gear input by the driver without performing a safety measure.

The EPB engagement includes a case where the system is deactivated by the driver engaging the EPB in a moving state of the vehicle.

The one minute pause includes a case where the system is deactivated by the driver maintaining a paused state for more than one minute.

The unfastened seat belt includes a case where the system is deactivated since a seat belt of a driver's seat is unfastened in a state of gear positions other than the P (Park) position during control and in an opened state of a door.

When the system deactivation does not correspond to a re-entry type, the automatic parking control apparatus (100) may initialize the system (S720). To do so, the automatic parking control apparatus (100) may clear the stored parking information and system settings. For instance, the system deactivation resulting from a vehicle collision is an example that does not correspond to a re-entry type.

When the system deactivation corresponds to a re-entry type, the automatic parking control apparatus (100) does not initialize the system. The automatic parking control apparatus (100) may maintain a standby state after the system is deactivated (S730).

The automatic parking control apparatus (100) may determine whether the vehicle is within a preset support range (S740). The support range refers to a predetermined area that allows the vehicle to resume automatic parking based on the previously searched parking space from its current position after the system is deactivated. For example, the support range may be set within 0.5 meters from the position where the system was deactivated.

The automatic parking control apparatus (100) may store the position of the vehicle at the time of deactivation of the automatic parking system, in the memory. The automatic parking control apparatus (100) may calculate the traveling distance of the vehicle by using vehicle information and parking space recognition information. The automatic parking control apparatus (100) may calculate the position of the vehicle, based on the calculated traveling distance. The automatic parking control apparatus (100) may re-calculate a parking path, based on the position of the moved vehicle. The automatic parking control apparatus (100) may perform parking control, based on the re-calculated parking path.

The automatic parking control apparatus (100) may determine whether a parking switch is input. The parking switch may include a parking/view button (S750).

The automatic parking control apparatus (100) determines whether the vehicle is within a preset support range while maintaining a standby state when a parking switch input is not detected.

The automatic parking control apparatus (100) may prompt the user, via the HMI, to confirm whether to re-enter automatic parking when a parking switch input is detected (S760).

The user may select whether to resume automatic parking using the parking space information stored in the memory of the automatic parking control apparatus (100) or to start a new automatic parking operation. For example, the user may make the selection using a head unit.

When user chooses to resume automatic parking based on the stored parking space information, the automatic parking control apparatus (100) assumes control and resumes automatic parking (S770).

When starting a new automatic parking operation, the automatic parking control apparatus (100) may initialize the system, check the current state of the vehicle against the predefined RSPA entry conditions, and enter RSPA if the conditions are met (S780). For example, the automatic parking control apparatus (100) may first clear previously stored parking information and settings to initialize the system. After initialization, the apparatus (100) may check parameters such as the gear position, vehicle speed, and sensor information, and determine whether the predefined RSPA entry conditions are satisfied. If the conditions are satisfied, the automatic parking control apparatus (100) may initiate the RSPA mode for automatic parking control

When the automatic parking system is deactivated due to a failure in following an operation sequence or an operation method, the information on the parking space is initialized, and there is a problem in that the user needs to search for the parking space again from the beginning when the user wants to resume the automatic parking. As an example, referring to FIG. 1, when the user presses and holds the parking/view button and takes his/her foot off the brake pedal in accordance with the operation sequence of the RSPA system, a smart parking function is fulfilled. However, when the user takes his/her foot off the brake pedal before pressing the parking/view button and the vehicle moves, the system is deactivated.

According to one embodiment of the present disclosure, when the user takes his/her foot off the brake pedal and the vehicle moves before the parking/view button is pressed, the system is deactivated, but the automatic parking control apparatus (100) may store the searched parking space in the memory without initializing the system.

The automatic parking control apparatus (100) may show the parking space stored in the memory to the user using a User Experience (UX) when the user presses the parking/view button to resume the smart parking.

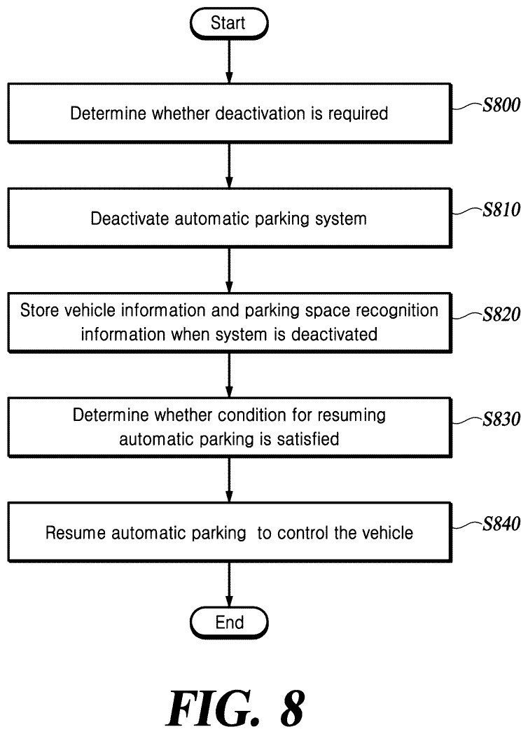

FIG. 8 is a flowchart illustrating a method for resuming automatic parking according to one embodiment of the present disclosure.

The automatic parking control apparatus (100) may detect and determine whether a situation requiring deactivation of the automatic parking system has occured (S800). As an example, the deactivation situation of the automatic parking system may include a situation where the system is deactivated in such a manner that the user reverses or overrides the vehicle before the vehicle is controlled after the parking space is completely searched for. As another example, the deactivation situation of the automatic parking system may include a situation where the system needs to be deactivated due to the user intervention during vehicle control. As still another example, the deactivation situation of the automatic parking system may include a situation where the system is deactivated due to a failure in following the operation sequence or the operation method of the automatic parking system.

The automatic parking control apparatus (100) may deactivate the automatic parking system upon determining that the automatic parking system is in the deactivation situation (S810).

The automatic parking control apparatus (100) may store automatic parking operation step information of the vehicle, vehicle information, and parking space recognition information in the memory when the automatic parking system is deactivated (S820).

The automatic parking control apparatus (100) may determine whether conditions for resuming the automatic parking are satisfied (S830).

As an example, when the system is deactivated in such a manner that the user reverses or overrides the vehicle before the vehicle is controlled after the parking space is completely searched for, the automatic parking control apparatus (100) may determine whether the vehicle reaches a scan completion point again. The scan completion point may refer to a corner point of the searched parking space that is closest to the position where automatic parking control can be initiated according to the selected parking type. That is, the scan completion point may serve as a final scan reference point before reactivating the system or as an automatic parking resumption point.

As another example, when the system is deactivated due to the user intervention during the vehicle control, the automatic parking control apparatus (100) may determine whether the situation where the system is deactivated due to the user intervention corresponds to the re-entry type. The automatic parking control apparatus (100) may receive an input to resume the automatic parking by using the stored parking space recognition information. Specifically, the user may select whether to resume the automatic parking by using the information on the parking space which is stored in the memory of the automatic parking control apparatus (100) or whether to start the automatic parking anew. When the user intends to resume the automatic parking by using the parking space recognition information stored in the memory, the user may transmit an input to resume the automatic parking to the automatic parking control apparatus (100).

As another example, when the system is deactivated due to a failure in following the operation procedure or method of the automatic parking system, the automatic parking control apparatus (100) may receive an input from the user to resume the automatic parking.

The automatic parking control apparatus (100) may resume the automatic parking, and may control the vehicle by using the automatic parking operation step information, the vehicle information, and the parking space recognition information (S840).

The automatic parking control apparatus (100) may calculate the movement distance of the vehicle by using the vehicle information and the parking space recognition information. The automatic parking control apparatus (100) may calculate the position of the vehicle, based on the calculated movement distance. The automatic parking control apparatus (100) may re-calculate a path for parking the vehicle in the parking space, based on the position of the moved vehicle. The automatic parking control apparatus (100) may perform the parking control, based on the re-calculated parking path.

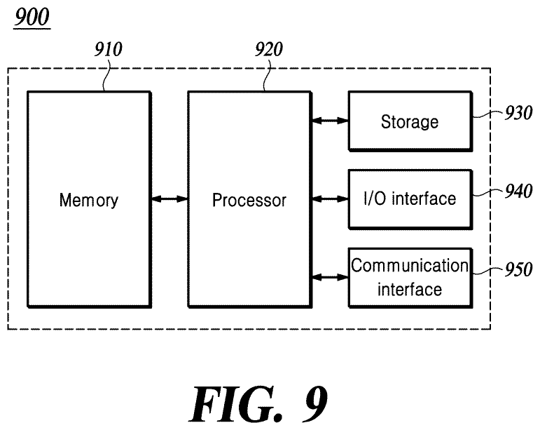

FIG. 9 is a block diagram schematically illustrating an exemplary computing device which may be used to implement a method or an apparatus according to the present disclosure.

The computing device (900) may include some or all of a memory (910), a processor (920), storage (930), an input/output interface (940), and a communication interface (950). The computing device (900) may structurally and/or functionally include at least a portion of the automatic parking control apparatus (100). The computing device (900) may be not only a stationary computing device such as a desktop computer and a server, but also a mobile computing device such as a laptop computer, a smartphone, and an automotive electronic device. The computing device (900) may be implemented as any specialized hardware accelerator which may efficiently process operations for an artificial intelligence model. For example, the computing device (900) may include a graphic processing unit (GPU), a Tensor Processing Unit (TPU), or a neural processing unit (NPU).

The memory (910) may store the vehicle information and the parking space recognition information. The memory (910) may store a program that causes the processor (920) to perform a method or an operation according to various embodiments of the present disclosure. As an example, the program may include a plurality of instructions executable by the processor (920), and the above-described method or the above-described operation may be performed by causing the processor (920) to execute the plurality of instructions. The memory (910) may be a single memory or a plurality of memories. In this case, information required for performing the method or the operation according to various embodiments of the present disclosure may be stored in the single memory, or may be divided and stored in the plurality of memories. When the memory (910) includes the plurality of memories, the plurality of memories may be physically separated. The memory (910) may include at least one of a volatile memory and a nonvolatile memory. The volatile memory includes a static random access memory (SRAM) or a dynamic random access memory (DRAM), and the nonvolatile memory includes a flash memory, and the like.

The processor (920) may include at least one core which may execute at least one instruction. The processor (920) may execute instructions stored in the memory (910). The processor (920) may be a single processor or a plurality of processors.

The storage (930) maintains stored data even when power supplied to the computing device (900) is cut off. For example, the storage (930) may include a nonvolatile memory, and may include storage media such as a magnetic tape, an optical disk, and a magnetic disk. A program stored in the storage (930) may be loaded into the memory (910) before being executed by the processor (920). The storage (930) may store a file written in a programming language, and a program generated from the file by a compiler or the like may be loaded into the memory (910). The storage (930) may store data to be processed by the processor (920) and/or data processed by the processor (920).

The input/output interface (940) may provide an interface with an input device such as a keyboard and a mouse and/or an output device such as a display device and a printer. The user may trigger causing the processor (920) to execute the program through an input device and/or may confirm a processing result of the processor (920) through the output device.

The communication interface (950) may provide access to an external network. The computing device (900) may communicate with other devices through the communication interface (950).

The apparatus or method according to an exemplary embodiment of the present disclosure may include the respective components provided to be implemented as hardware or software, or hardware and software combined. Additionally, each component may be functionally implemented by software, and a microprocessor may execute the function by software for each component when implemented.

Various illustrative implementations of the systems and methods described herein may be realized by digital electronic circuitry, integrated circuits, field-programmable gate arrays (FPGAs), application-specific integrated circuits (ASICs), computer hardware, firmware, software, and/or their combination. These various implementations may include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. The computer programs (which are also known as programs, software, software applications, or code) include instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording mediums may further include transitory media such as a data transmission medium. Furthermore, the computer-readable recording medium can be distributed in computer systems connected via a network, wherein the computer-readable codes can be stored and executed in a distributed mode.

Although the steps in the respective flowcharts are described to be sequentially performed, they merely instantiate the technical idea of various exemplary embodiments of the present disclosure. Therefore, a person having ordinary skill in the pertinent art could perform the steps by changing the sequences described in the respective flowcharts or by performing two or more of the steps in parallel, and hence the steps in the respective flowcharts are not limited to the illustrated chronological sequences.

In various exemplary embodiments of the present disclosure, each operation described above may be performed by a control device, and the control device may be conFIGured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the FIGures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the claims appended hereto and their equivalents.

What is claimed is:

1. A method for resuming automatic parking of a vehicle, the method comprising:
determining, by a processor, whether deactivation of an automatic parking system is required;
deactivating, by the processor, the automatic parking system in response to determining that the deactivation is required;
determining, by the processor, whether a condition for resuming automatic parking is satisfied; and
reactivating, by the processor, the automatic parking system based on prior vehicle position information and parking space recognition information in response to determining that the condition for resuming is satisfied.

2. A method for resuming automatic parking of a vehicle, the method comprising:
determining, by a processor, whether deactivation of an automatic parking system is required;
deactivating, by the processor, the automatic parking system in response to determining that the deactivation is required;
storing, by the processor, at a time point when the automatic parking system is deactivated, vehicle position information and parking space recognition information;
determining, by the processor, whether a condition for resuming automatic parking is satisfied; and
reactivating, by the processor, the automatic parking system based on the stored vehicle position information and the stored parking space recognition information in response to determining that the condition for resuming is satisfied.

3. The method of claim 2, wherein determining whether the deactivation of the automatic parking system is required comprises determining that deactivation is required in response to a user manually moving the vehicle before automatic parking control is initiated after completion of parking space recognition.

4. The method of claim 3, wherein determining whether the condition for resuming automatic parking is satisfied comprises determining whether the vehicle reaches a scan completion point again.

5. The method of claim 2, wherein determining whether the deactivation of the automatic parking system is required comprises determining that deactivation is required in response to user intervention detected during operation of the system.

6. The method of claim 5, wherein determining whether the condition for resuming the automatic parking is satisfied comprises determining whether system deactivation caused by user intervention corresponds to a re-entry type.

7. The method of claim 5, wherein determining whether the condition for resuming the automatic parking is satisfied comprises receiving a user input to resume automatic parking using the stored parking space recognition information.

8. The method of claim 2, wherein determining whether deactivation of the automatic parking system is required comprises determining that deactivation is required in response to a user failing to follow an operation procedure of the automatic parking system.

9. The method of claim 8, wherein determining whether the condition for resuming the automatic parking is satisfied comprises receiving a user input to resume automatic parking using the stored parking space recognition information.

10. The method of claim 2, further comprising:
determining whether a time point for re-displaying the parking space is reached after a user has moved the vehicle again; and
visually displaying the parking space recognition information to the user in response to determining that the time point for re-displaying the parking space is reached,
wherein the time point for re-displaying the parking space is a moment when the vehicle reaches a position where automatic parking control according to the selected parking type can be initiated.

11. The method of claim 2, wherein reactivating the automatic parking system comprises:
calculating a traveling distance between a position of the vehicle when the automatic parking system was deactivated and a current position of the vehicle;
updating a parking path based on the stored parking space recognition information, the traveling distance and the current position of the vehicle; and
controlling automatic parking of the vehicle based on the updated parking path.

12. An apparatus for resuming automatic parking of a vehicle, the apparatus comprising:
at least one processor; and
at least one memory coupled with the at least one processor to be operable,
wherein the at least one memory stores instructions that cause the at least one processor to perform operations of:
determining whether deactivation of an automatic parking system is required;
deactivating the automatic parking system in response to determining that the deactivation is required;
storing, at a time point when the automatic parking system is deactivated, vehicle position information and parking space recognition information;
determining whether a condition for resuming automatic parking is satisfied; and
reactivating the automatic parking system based on the stored vehicle position information and the stored parking space recognition information in response to determining that the condition for resuming is satisfied.

13. The apparatus of claim 12, wherein determining whether the deactivation of the automatic parking system is required comprises determining that deactivation is required in response to a user manually moving the vehicle before automatic parking control is initiated after completion of parking space recognition.

14. The apparatus of claim 13, determining whether the condition for resuming automatic parking is satisfied comprises determining whether the vehicle reaches a scan completion point again.

15. The apparatus of claim 12, wherein determining whether the deactivation of the automatic parking system is required comprises determining that deactivation is required in response to user intervention detected during operation of the system.

16. The apparatus of claim 15, wherein determining whether the condition for resuming the automatic parking is satisfied comprises determining whether system deactivation caused by user intervention corresponds to a re-entry type.

17. The apparatus of claim 15, wherein determining whether the condition for resuming the automatic parking is satisfied comprises receiving a user input to resume automatic parking using the stored parking space recognition information.

18. The apparatus of claim 12, wherein determining whether deactivation of the automatic parking system is required comprises determining that deactivation is required in response to a user failing to follow an operation procedure of the automatic parking system, and wherein determining whether the condition for resuming the automatic parking is satisfied comprises receiving a user input to resume automatic parking using the stored parking space recognition information.

19. The apparatus of claim 12, wherein the operations further comprise:
determining whether a time point for re-displaying the parking space is reached after a user has moved the vehicle again; and
visually displaying the parking space recognition information to the user in response to determining that the time point for re-displaying the parking space is reached,
wherein the time point for re-displaying the parking space is a moment when the vehicle reaches a position where automatic parking control according to the selected parking type can be initiated.

20. The apparatus of claim 12, wherein reactivating the automatic parking system comprises:
calculating a traveling distance between a position of the vehicle when the automatic parking system was deactivated and a current position of the vehicle;
updating a parking path based on the stored parking space recognition information, the traveling distance and the current position of the vehicle; and
controlling automatic parking of the vehicle based on the updated parking path.
